(19) United States
(12) Patent Application Publication
(10) Pub. No.: US 2024/0337898 A1
(43) Pub. Date: Oct. 10, 2024

(54) WAVELENGTH CONVERSION DEVICE AND WAVELENGTH CONVERSION SYSTEM

(71) Applicant: NGK INSULATORS, LTD., Nagoya-Shi (JP)

(72) Inventors: Kentaro TANI, Nagoya-Shi (JP); Jungo KONDO, Miyoshi-Shi (JP); Tetsuya EJIRI, Kasugai-Shi (JP); Shoichiro YAMAGUCHI, Ichinomiya-Shi (JP)

(73) Assignee: NGK INSULATORS, LTD., Nagoya-Shi (JP)

(21) Appl. No.: 18/739,443

(22) Filed: Jun. 11, 2024

Related U.S. Application Data
(63) Continuation of application No. PCT/JP2023/001484, filed on Jan. 19, 2023.

(30) Foreign Application Priority Data
Feb. 17, 2022 (JP) 2022-023221

(51) Int. Cl. G02F 1/35; G02F 1/355; G02F 1/377; G02F 1/39

(52) U.S. Cl. CPC G02F 1/353; G02F 1/3551; G02F 1/3775; G02F 1/395; G02F 2202/32

(57) ABSTRACT

A wavelength conversion device includes: a dielectric substrate having holes periodically formed in a non-linear optical crystal substrate; a line-defect optical waveguide formed in the dielectric substrate; and a periodically poled portion provided in the optical waveguide. The wavelength conversion device is configured to convert a wavelength of light traveling through the optical waveguide.

### CROSS-REFERENCE TO RELATED APPLICATIONS

This application is a continuation under 35 U.S.C. 120 of International Application PCT/JP2023/001484 having the International Filing Date of 19 Jan. 2023 and having the benefit of the earlier filing dates of Japanese Application No. 2022-023221, filed on 17 Feb. 2022. Each of the identified applications is fully incorporated herein by reference.

### BACKGROUND OF THE INVENTION

### 1. Field of the Invention

The present invention relates to a wavelength conversion device and a wavelength conversion system.

### 2. Description of the Related Art

Development of a wavelength conversion device as one of non-linear optical devices is being advanced. The wavelength conversion device is expected to be applied to and deployed in a wide range of fields including next-generation optical communication and quantum technology. As such a wavelength conversion device, various device structures for giving the wavelength conversion device a high conversion efficiency and high power are being developed. As an example of this kind of wavelength conversion device, there has been proposed a technology of providing a thin-film layer which is placed on a substrate and which includes a wavelength conversion material with a light confinement portion for confining input light and a light radiation portion (photonic crystal) for emitting converted light to a direction different from a traveling direction of the input light (see, for example, Patent Literature 1). With the technology of Patent Literature 1, however, the range of wavelengths of the converted light that can be emitted is limited, and it is also difficult to propagate the converted light to a desired position.

### CITATION LIST

### Patent Literature

[PTL 1] JP 2008-209522 A

### SUMMARY OF THE INVENTION

A primary object of the present invention is to provide a wavelength conversion device and a wavelength conversion system that are capable of outputting light in a wide band of wavelengths and stably propagating input light and output light.

[1] According to one embodiment of the present invention, there is provided a wavelength conversion device including: a dielectric substrate having holes periodically formed in a non-linear optical crystal substrate; a line-defect optical waveguide formed in the dielectric substrate; and a periodically poled portion provided in the line-defect optical waveguide, wherein the wavelength conversion device is configured to convert a wavelength of light traveling through the line-defect optical waveguide.

[2] In the wavelength conversion device according to the above-mentioned item [1], the dielectric substrate may be configured to function as one of a photonic crystal and an effective-medium-clad dielectric with respect to at least one beam of input light input to the line-defect optical waveguide, and function as another of the photonic crystal and the effective-medium-clad dielectric with respect to at least one beam of output light output from the line-defect optical waveguide.

[3] In the wavelength conversion device according to the above-mentioned item [2], the line-defect optical waveguide may be configured to receive input light input thereto, and output first output light and second output light which are lower in frequency than the input light.

[4] In the wavelength conversion device according to the above-mentioned item [3], the dielectric substrate may be configured to function as the photonic crystal with respect to the input light, and function as the effective-medium-clad dielectric with respect to the first output light and the second output light.

[5] In the wavelength conversion device according to the above-mentioned item [3], the dielectric substrate may be configured to function as the photonic crystal with respect to the input light and the first output light, and function as the effective-medium-clad dielectric with respect to the second output light.

[6] In the wavelength conversion device according to the above-mentioned item [1], the dielectric substrate may be configured to function as an effective-medium-clad dielectric with respect to the input light, the first output light, and the second output light.

[7] In the wavelength conversion device according to any one of the above-mentioned items [3] to [6], the input light, the first output light, and the second output light may satisfy the following equation (1-1) and the following equation (2-1):

$${ω}_{IN - 1} = {ω}_{OUT - 1} + {ω}_{OUT - 2} \qquad ( 1 - 1 )$$

where ω_{IN-1} represents an angular frequency of the input light, ω_{OUT-1} represents an angular frequency of the first output light, and ω_{OUT-2} represents an angular frequency of the second output light; and

$$\frac{{ω}_{IN - 1} {n}_{IN - 1}}{c} = \frac{{ω}_{OUT - 1} {n}_{OUT - 1}}{c} + \frac{{ω}_{OUT - 2} {n}_{OUT - 2}}{c} \pm \frac{2 π}{Λ} \qquad ( 2 - 1 )$$

where n_{IN-1} represents a refractive index of the non-linear optical crystal substrate with respect to the input light at a predetermined temperature, n_{OUT-1} represents a refractive index of the non-linear optical crystal substrate with respect to the first output light at the predetermined temperature, n_{OUT-2} represents a refractive index of the non-linear optical crystal substrate with respect to the second output light at the predetermined temperature, “c” represents a light speed, A represents a poling period in the periodically poled portion, and ω_{IN-1}, ω_{OUT-1}, and ω_{OUT-2} represent the same angular frequencies as the angular frequencies in the equation (1-1), and ω_{OUT-1} may be equal to ω_{OUT-2}. There is a condition under which a plurality of combinations of ω_{OUT-1} and ω_{OUT-2} are simultaneously present for one ω_{IN-1}. In this case, the output light has a wide band of wavelengths.

[8] In the wavelength conversion device according to the above-mentioned item [2], the line-defect optical waveguide may be configured to: receive first input light and second input light which are input thereto, the second input light being lower in frequency than the first input light; output first output light obtained by amplifying the second input light; and output second output light lower in frequency than the first input light.

[9] In the wavelength conversion device according to the above-mentioned item [8], the dielectric substrate may be configured to function as the photonic crystal with respect to the first input light, and function as the effective-medium-clad dielectric with respect to the second input light, the first output light, and the second output light.

[10] In the wavelength conversion device according to the above-mentioned item [8], the dielectric substrate may be configured to function as the photonic crystal with respect to the first input light, the second input light, and the first output light, and function as the effective-medium-clad dielectric with respect to the second output light.

[11] In the wavelength conversion device according to the above-mentioned item [8], the dielectric substrate may be configured to function as the photonic crystal with respect to the first input light and the second output light, and function as the effective-medium-clad dielectric with respect to the second input light and the first output light.

[12] In the wavelength conversion device according to the above-mentioned item [1], the dielectric substrate may be configured to function as an effective-medium-clad dielectric with respect to the first input light, the second input light, the first output light, and the second output light.

[13] In the wavelength conversion device according to any one of the above-mentioned items [8] to [12], the first input light, the second input light, the first output light, and the second output light may satisfy the following equation (1-2A), the following equation (1-2B), and the following equation (2-2):

$${ω}_{IN - 1} = {ω}_{OUT - 1} + {ω}_{OUT - 2} \qquad ( 1 - 2 A )$$

where ω_{IN-1} represents an angular frequency of the first input light, ω_{OUT-1} represents an angular frequency of the first output light, and ω_{OUT-2} represents an angular frequency of the second output light;

$${ω}_{IN - 2} = {ω}_{OUT - 1} \qquad ( 1 - 2 B )$$

where ω_{IN-2} represents an angular frequency of the second input light, and ω_{OUT-1} represents the angular frequency of the first output light; and

$$\frac{{ω}_{IN - 1} {n}_{IN - 1}}{c} = \frac{{ω}_{OUT - 1} {n}_{OUT - 1}}{c} + \frac{{ω}_{OUT - 2} {n}_{OUT - 2}}{c} \pm \frac{2 π}{Λ} \qquad ( 2 - 2 )$$

where n_{IN-1} represents a refractive index of the non-linear optical crystal substrate with respect to the first input light at a predetermined temperature, n_{OUT-1} represents a refractive index of the non-linear optical crystal substrate with respect to the first output light at the predetermined temperature, n_{OUT-2} represents a refractive index of the non-linear optical crystal substrate with respect to the second output light at the predetermined temperature, “c” represents a light speed, A represents a poling period in the periodically poled portion, and ω_{IN-1}, ω_{OUT-1}, and ω_{OUT-2} represent the same angular frequencies as the angular frequencies in the equation (1-2A).

[14] In the wavelength conversion device according to the above-mentioned item [2], the line-defect optical waveguide may be configured to receive input light input thereto, and output output light higher in frequency than the input light.

[15] In the wavelength conversion device according to the above-mentioned item [14], the dielectric substrate may be configured to function as the effective-medium-clad dielectric with respect to the input light, and function as the photonic crystal with respect to the output light.

[16] In the wavelength conversion device according to the above-mentioned item [1], the dielectric substrate may be configured to function as an effective-medium-clad dielectric with respect to the input light and the output light.

[17] In the wavelength conversion device according to any one of the above-mentioned items to [16], the input light and the output light may satisfy the following equation (1-3) and the following equation (2-3):

$$2 {ω}_{IN - 1} = {ω}_{OUT - 1} \qquad ( 1 - 3 )$$

where ω_{IN-1} represents an angular frequency of the input light, and ω_{OUT-1} represents an angular frequency of the output light; and

$$2 \frac{{ω}_{IN - 1} {n}_{IN - 1}}{c} \pm \frac{2 π c}{Λ} = \frac{{ω}_{OUT - 1} {n}_{OUT - 1}}{c} \qquad ( 2 - 3 )$$

where n_{IN-1} represents a refractive index of the non-linear optical crystal substrate with respect to the input light at a predetermined temperature, n_{OUT-1} represents a refractive index of the non-linear optical crystal substrate with respect to the output light at the predetermined temperature, “c” represents a light speed, A represents a poling period in the periodically poled portion, and ω_{IN-1} and ω_{OUT-1} represent the same angular frequencies as the angular frequencies in the equation (1-3).

[18] In the wavelength conversion device according to the above-mentioned item [2], the line-defect optical waveguide may be configured to: receive first input light and second input light which are input thereto, the second input light being lower in frequency than the first input light; and output output light higher in frequency than the first input light and the second input light.

[19] In the wavelength conversion device according to the above-mentioned item [18], the dielectric substrate may be configured to function as the photonic crystal with respect to the output light, and function as the effective-medium-clad dielectric with respect to the first input light and the second input light.

[20] In the wavelength conversion device according to the above-mentioned item [18], the dielectric substrate may be configured to function as the photonic crystal with respect to the first input light and the output light, and function as the effective-medium-clad dielectric with respect to the second input light.

[21] In the wavelength conversion device according to the above-mentioned item [1], the dielectric substrate may be configured to function as an effective-medium-clad dielectric with respect to the first input light, the second input light, and the output light.

[22] In the wavelength conversion device according to any one of the above-mentioned items to [21], the first input light, the second input light, and the output light may satisfy the following equation (1-4) and the following equation (2-4):

$${ω}_{IN - 1} + {ω}_{IN - 2} = {ω}_{OUT - 1} \qquad ( 1 - 4 )$$

where ω_{IN-1} represents an angular frequency of the first input light, ω_{IN-2} represents an angular frequency of the second input light, and ω_{OUT-1} represents a frequency of the output light; and

$$\frac{{ω}_{IN - 1} {n}_{IN - 1}}{c} + \frac{{ω}_{IN - 2} {n}_{IN - 2}}{c} \pm \frac{2 π c}{Λ} = \frac{{ω}_{OUT - 1} {n}_{OUT - 1}}{c} \qquad ( 2 - 4 )$$

where n_{IN-1} represents a refractive index of the non-linear optical crystal substrate with respect to the first input light at a predetermined temperature, n_{IN-2} represents a refractive index of the non-linear optical crystal substrate with respect to the second input light at the predetermined temperature, n_{OUT-1} represents a refractive index of the non-linear optical crystal substrate with respect to the output light at the predetermined temperature, “c” represents a light speed, A represents a poling period in the periodically poled portion, and ω_{IN-1}, ω_{IN-2}, and ω_{OUT-1} represent the same angular frequencies as the angular frequencies in the equation (1-4).

[23] In the wavelength conversion device according to any one of the above-mentioned items [2] to [22], out of the input light and the output light, light propagated to the dielectric substrate in a photonic crystal mode may satisfy the following equation (3), and light propagated to the dielectric substrate in an effective-medium-clad dielectric mode may satisfy the following equation (4):

$$0.35 ≦ \frac{{ω}_{X} α}{2 π c} ≦ 0.45 \qquad ( 3 )$$

where ω_{X} represents an angular frequency of the light propagated to the dielectric substrate in the photonic crystal mode, a represents a period of a periodic hole array, and “c” represents a light speed; and

$$0.001 ≦ \frac{{ω}_{Y} α}{2 π c} ≦ 0.3499 \qquad ( 4 )$$

where ω_{Y} represents an angular frequency of the light propagated to the dielectric substrate in the effective-medium-clad dielectric mode, a represents the period of the periodic hole array, and “c” represents the light speed.

[24] The wavelength conversion device according to any one of the above-mentioned items [1] to may further include: a support substrate provided below the non-linear optical crystal substrate; and a low-refractive index portion which has a refractive index lower than a refractive index of the non-linear optical crystal substrate, and which is positioned between the non-linear optical crystal substrate and the support substrate. At least part of the low-refractive index portion may overlap with the line-defect optical waveguide in a thickness direction of the non-linear optical crystal substrate.

[25] The wavelength conversion device according to any one of the above-mentioned items [1] to may further include a diffraction grating which is provided in the line-defect optical waveguide, and which is arranged so as to be side by side with the periodically poled portion in a waveguide direction of the line-defect optical waveguide. The wavelength conversion device is configured to emit, from the line-defect optical waveguide, light converted in wavelength in the line-defect optical waveguide.

[26] The wavelength conversion device according to any one of the above-mentioned items [1] to may further include a first electrode and a second electrode which are electrically connected to the non-linear optical crystal substrate.

[27] According to another aspect of the present invention, there is provided a wavelength conversion system including: the wavelength conversion device of any one of the above-mentioned items [1] to [26]; and a control unit configured to control a refractive index of the non-linear optical crystal substrate.

[28] The wavelength conversion system according to the above-mentioned item may further include: a first electrode and a second electrode which are electrically connected to the non-linear optical crystal substrate, and which are positioned at an interval from each other; and a power source configured to apply a voltage to the first electrode and the second electrode. The control unit is configured to control the power source, and adjust the refractive index of the non-linear optical crystal substrate by controlling the voltage applied to the first electrode and the second electrode.

According to the embodiment of the present invention, the wavelength conversion device and the wavelength conversion system that are capable of outputting light in a wide band of wavelengths and stably propagating input light and output light can be achieved.

### BRIEF DESCRIPTION OF THE DRAWINGS

FIG. 1A is a schematic configuration diagram of a wavelength conversion system including a wavelength conversion device according to an embodiment of the present invention. FIG. 1B is a schematic configuration diagram of a periodically poled portion illustrated in FIG. 1A.

FIG. 2 is a schematic perspective view of a wavelength conversion device according to another embodiment of the present invention.

FIG. 3 is a schematic perspective view of a wavelength conversion device according to still another embodiment of the present invention.

FIG. 4A to FIG. 4E are schematic sectional views for illustrating a method of manufacturing a wavelength conversion device according to an embodiment of the present invention, with FIG. 4A being an illustration of a step of preparing a non-linear optical crystal substrate, FIG. 4B being an illustration of a step of joining the non-linear optical crystal substrate and a support substrate to each other, FIG. 4C being an illustration of a step of polishing the non-linear optical crystal substrate, FIG. 4D being an illustration of a step of forming a hole, and FIG. 4E being an illustration of a step of forming a first electrode and a second electrode.

FIG. 5 is a graph for showing a correlation between a propagation constant and an angular frequency of light in parametric down-conversion in Example 1.

FIG. 6 is an explanatory diagram for illustrating shifts of band curves in a photonic crystal mode and an EMC mode in the parametric down-conversion in Example 1.

### DESCRIPTION OF THE EMBODIMENTS

Embodiments of the present invention are described below. However, the present invention is not limited to those embodiments.

### A. Overall Configuration of Wavelength Conversion Device

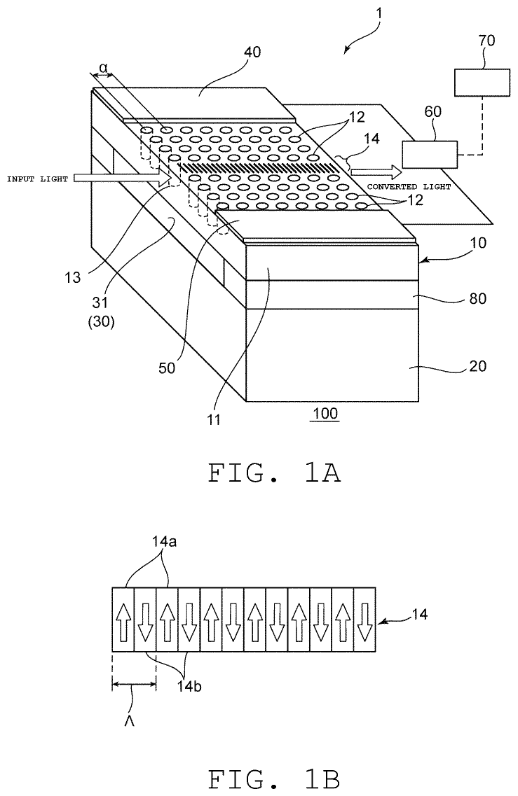

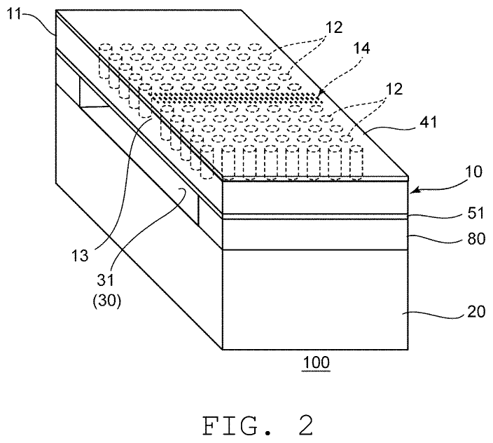

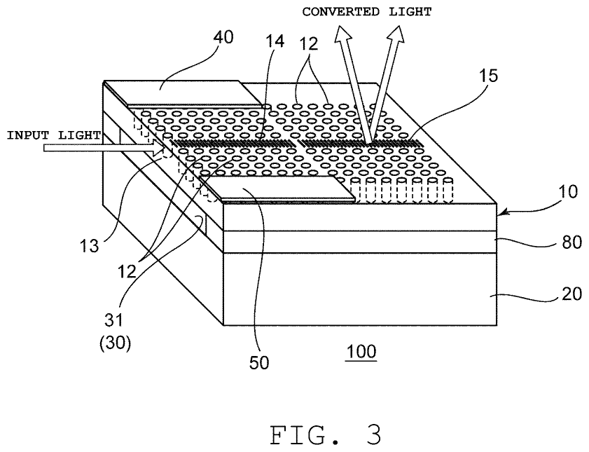

FIG. 1A is a schematic configuration diagram of a wavelength conversion system including a wavelength conversion device according to an embodiment of the present invention. FIG. 1B is a schematic configuration diagram of a periodically poled portion illustrated in FIG. 1A. FIG. 2 is a schematic perspective view of a wavelength conversion device according to another embodiment of the present invention. FIG. 3 is a schematic perspective view of a wavelength conversion device according to still another embodiment of the present invention.

As illustrated in FIG. 1A, a wavelength conversion device 100 includes: a dielectric substrate 10 having holes 12 periodically formed in a non-linear optical crystal substrate 11; a line-defect optical waveguide 13 formed in the dielectric substrate 10; and a periodically poled portion 14 provided in the optical waveguide 13. The wavelength conversion device 100 is configured to convert a wavelength of light traveling through the optical waveguide 13. The optical waveguide 13 is typically a line-defect waveguide defined as a portion in the non-linear optical crystal substrate 11 that has no holes 12 formed therein. A frequency of input light that is input to the optical waveguide 13 is typically 150 THz or more and 858 THz or less. To convert the frequency into a wavelength, a wavelength of the input light is approximately 350 nm or more and approximately 2 μm or less. A frequency of output light (converted light) that is output from the optical waveguide 13 is typically 20 THz or more and 857 THz or less. To convert the frequency into a wavelength, a wavelength of the output light (converted light) is approximately 350 nm or more and approximately 15 μm or less.

According to this configuration, the provision of the periodically poled portion in the optical waveguide enables conversion of the wavelength of light passing through the optical waveguide by quasi-phase matching (QPM). In addition, a refractive index of the non-linear optical crystal substrate can be modulated, and a band of convertible wavelengths of light can accordingly be widened by modulating the refractive index of the non-linear optical crystal substrate. Adjustment of the refractive index of the non-linear optical crystal substrate further enables the input light and the output light to each propagate through the optical waveguide in one of a photonic crystal mode and an effective-medium-clad dielectric mode (hereinafter referred to as “EMC mode”). Accordingly, in such a wavelength conversion device, the band of wavelengths of output light can be widened, and the input light and the output light can be propagated stably to a desired position without being radiated from the optical waveguide.

In one embodiment, the dielectric substrate 10 functions as one of a photonic crystal and an effective-medium-clad dielectric with respect to at least one beam of input light input to the optical waveguide 13, and functions as another of the photonic crystal and the effective-medium-clad dielectric with respect to at least one beam of output light output from the optical waveguide 13. According to this configuration, the band of wavelengths of output light can be widened satisfactorily, and more stable propagation of input light and output light is accomplished.

A photonic crystal is a multidimensional periodic structural body formed by arranging a medium high in refractive index and a medium low in refractive index in cycles comparable to the wavelength of light, and has a band structure of light resembling a band structure of an electron. A forbidden band (photonic band gap) is developed in a photonic crystal with respect to predetermined light. A photonic crystal having a forbidden band functions as an object that does not reflect or transmit light having a predetermined wavelength. Introduction of a line defect that disrupts cyclicity into a photonic crystal having a photonic band gap forms a waveguide mode in a frequency region of the band gap, and a waveguide that propagates light with a small loss can be attained as a result.

Meanwhile, in an effective-medium-clad dielectric, a forbidden band (photonic band gap) is not developed with respect to predetermined light. In this case, light is not diffracted at periodic holes, and the periodic holes function as a low-refractive index portion in effect. This equals to behaving as a clad in an optical fiber. Accordingly, when a line defect is introduced into an effective-medium-clad dielectric, the line defect portion behaves as a core in an optical fiber, and a waveguide that propagates light with a small propagation loss over a wide frequency range can consequently be attained.

In other words, at least one beam of input light propagates through the optical waveguide 13 in one of the photonic crystal mode and the effective-medium-clad dielectric mode (hereinafter referred to as “EMC mode”), and at least one beam of output light propagates through the optical waveguide 13 in another of the photonic crystal mode and the EMC mode.

In one embodiment, the wavelength conversion device 100 further includes a support substrate 20 and a low-refractive index portion 30. The support substrate 20 is provided below the dielectric substrate 10 to support the dielectric substrate 10. This improves strength of the wavelength conversion device, and accordingly enables the dielectric substrate (non-linear optical crystal substrate) to have a thin thickness. The low-refractive index portion 30 is positioned between the dielectric substrate 10 and the support substrate 20. The low-refractive index portion 30 is lower in refractive index than the non-linear optical crystal substrate 11. The low-refractive index portion 30 at least partially overlaps with the optical waveguide 13 in a thickness direction of the non-linear optical crystal substrate 11. This suppresses leakage of light that is propagating through the optical waveguide 13 to the support substrate. Accordingly, even in a mode in which the dielectric substrate is mounted on (supported by) the support substrate, propagating light can be stably confined in the optical waveguide, and an increase in propagation loss can accordingly be suppressed.

In one embodiment, the dielectric substrate 10 is joined directly to the support substrate 20. The term “direct joining” as used herein means that two layers or substrates are joined to each other without an intervening adhesive. The form of the direct joining may be appropriately set depending on the configuration of layers or substrates to be joined to each other. More specifically, the wavelength conversion device 100 further includes a joining portion 80 for joining the dielectric substrate 10 and the support substrate 20 to each other. This enables suppressing of peeling in the wavelength conversion device in a favorable manner, and damage (for example, a crack) caused to the dielectric substrate by such peeling can consequently be suppressed well.

In one embodiment, the wavelength conversion device 100 further includes a first electrode 40 and a second electrode 50 which are electrically connected to the non-linear optical crystal substrate 11 and which are positioned at an interval from each other. According to this configuration, a voltage is applicable to the non-linear optical crystal substrate via the first electrode and the second electrode, and accordingly, a refractive index of the non-linear optical crystal substrate can be modulated smoothly. The band of convertible wavelengths of light can accordingly be widened in a stable manner.

As illustrated in FIG. 3, the wavelength conversion device 100 may further include a diffraction grating 15. The diffraction grating 15 is arranged side by side with the periodically poled portion 14 in a waveguide direction of the optical waveguide 13. The diffraction grating 15 is provided in the optical waveguide 13. More specifically, the diffraction grating 15 is provided in at least one portion of the optical waveguide 13 selected from an upper portion, a left side surface portion, and a right side surface portion of the optical waveguide 13. In this case, the wavelength conversion device 100 can emit output light that has undergone wavelength conversion from an upper surface of the optical waveguide 13. The wavelength conversion device 100 can have the diffraction grating function as a light deflector by changing the wavelength of output light through an electro-optical effect, and thus controlling a diffraction angle (emission angle) in the diffraction grating. Emitted light beams (laser light) from the optical waveguide 13 are so-called fan beams that are line shapes in plan view (line shapes in a direction perpendicular to the waveguide direction) and are a fan shape when viewed from the waveguide direction. The periodic holes forming the optical waveguide 13 may differ in hole period and hole diameter between a region in which the periodically poled portion 14 is provided and a region in which the diffraction grating 15 is provided. Under some conditions, output light of the wavelength conversion device 100 has a wide band of wavelengths without voltage application. In this case, emitted light having an emission angle that varies depending on the wavelength can be obtained from the diffraction grating 15, and emitted light beams (laser light) from the optical waveguide 13 are beams that spread two-dimensionally in plan view.

The term “wavelength conversion device” as used herein encompasses both of a wafer (wavelength conversion device wafer) having formed thereon at least one wavelength conversion device and a chip obtained by cutting the wavelength conversion device wafer.

### B. Components of Wavelength Conversion Device

Each component of the wavelength conversion device is described next with reference to FIG. 1 to FIG. 3.

### B-1. Non-Linear Optical Crystal Substrate (Dielectric Substrate)

As illustrated in FIGS. 1, the non-linear optical crystal substrate 11 includes an upper surface exposed to the outside and a lower surface positioned in a composite substrate. The non-linear optical crystal substrate 11 is made of a non-linear optical material, preferably a single crystal of a non-linear optical material. Any appropriate material may be used as the non-linear optical material as long as the effects achieved in the embodiment of the present invention can be obtained. As such a material, there are typically given lithium niobate (LiNbO₃: LN), lithium tantalate (LiTaO₃: LT), potassium titanate phosphate (KTiOPO₄: KTP), potassium lithium niobate (KₓLi₍₁₋ₓ₎NbO₂: KLM), potassium niobate (KNbO₃: KN), potassium tantalate niobate (KNbₓTa₍₁₋ₓ₎O₃: KTN), a solid solution of lithium niobate and lithium tantalate, KTP (KTiOPO₄), and KTN (KTa₍₁₋ₓ₎NbₓO₃), preferably lithium niobate (LN). When lithium niobate or lithium tantalate is used, lithium niobate or lithium tantalate doped with MgO, or the crystal thereof having stoichiometric composition may be used for suppressing optical damage. In addition, an organic non-linear optical crystal (electro-optical polymer) such as 4-dimethylamino-N-methyl-4-stilbazolium tosylate (DAST), or an orientation-patterned gallium arsenide (OP—GaAs) crystal may be used.

The non-linear optical crystal substrate 11 may be an X-cut substrate or a Y-cut substrate. The non-linear optical crystal substrate 11 is preferably a Y-cut substrate, more preferably a Y-cut substrate with an off-cut angle of 5°. A thickness of the non-linear optical crystal substrate 11 may be set to any appropriate value. The thickness of the non-linear optical crystal substrate 11 may be, for example, from 0.07 μm to 5.0 μm. To give another example, the thickness of the non-linear optical crystal substrate 11 may be from 0.1 μm to 1.5 μm.

A refractive index “n” of the non-linear optical crystal substrate 11 at 200 THz is typically 2.0 or more and 4.0 or less, preferably, 2.1 or more and 3.8 or less.

The holes 12 are periodically formed in the non-linear optical crystal substrate 11.

As described above, the holes 12 may be formed as a periodic pattern. The holes 12 are typically arrayed so as to form regular lattices. Any appropriate form may be adopted as the form of each of the lattices. Typical examples thereof include a triangular lattice and a square lattice. In one embodiment, the holes 12 may be through-holes. The through-holes are easy to form, and as a result, their refractive indices are easy to adjust. Any appropriate shape may be adopted as the plan-view shape of each of the holes (through-holes). Specific examples thereof include equilateral polygons (for example, an equilateral triangle, a square, an equilateral pentagon, an equilateral hexagon, and an equilateral octagon), a substantially circular shape, and an elliptical shape. Of those, a substantially circular shape is preferred.

The ratio of the long diameter of the substantially circular shape to the short diameter thereof is preferably from 0.90 to 1.10, more preferably from 0.95 to 1.05. The holes 12 may be low-refractive index pillars (pillar-shaped portions each including a low-refractive index material). However, the through-holes are easier to form, and the through-holes each include air having the lowest refractive index. Accordingly, a difference in refractive index between each of the through-holes and the waveguide can be made larger. In addition, part of hole diameters may be different from the other hole diameters, and part of hole periods may also be different from the other hole periods.

A hole period α (a period α of a periodic hole array) is, for example, 0.02 μm or more and 3.5 μm or less, preferably 0.10 μm or more and 1.4 μm or less, more preferably 0.30 μm or more and 0.80 μm or less. A diameter of each hole relative to the hole period α is preferably from 0.25α to 0.95α, more preferably from 0.50α to 0.90α.

In the illustrated example, the holes 12 function as low-refractive index pillars, a portion between the holes 12 and 12 of the non-linear optical crystal substrate 11 functions as a high-refractive index portion, the low-refractive index portion functions as a lower clad, and an external environment (air portion) above the dielectric substrate 10 functions as an upper clad. A portion in the non-linear optical crystal substrate 11 that has no periodic pattern of the holes 12 formed therein serves as a line defect, and the line defect portion forms the optical waveguide 13. Although the optical waveguide 13 is belt-like (shaped like a straight line) in the illustrated example, a waveguide of a predetermined shape (accordingly, in a predetermined waveguide direction) can be formed by changing the defect pattern in which no periodic pattern is formed. For example, the waveguide may stretch in a direction that is at a predetermined angle (an oblique direction) relative to a longer side direction or a shorter side direction of the wavelength conversion device, or may bend at a predetermined point (the waveguide direction may change at a predetermined point).

The length of the optical waveguide 13 is, for example, 30 mm or less, preferably from 0.1 mm to 10 mm. The width of the optical waveguide 13 may be, for example, from 1.01α to 3α (2α in the illustrated example) with respect to the hole period α. The number of the rows of the holes (hereinafter sometimes referred to as “lattice rows”) in the waveguide direction may be from 3 to 10 (4 in the illustrated example) on each side of the waveguide.

The diameter of each hole, the hole period α, the number of lattice rows, the number of holes in one lattice row, the thickness of the non-linear optical crystal substrate, the constituent material (substantially, the refractive index) of the non-linear optical crystal substrate, the width of the line defect portion, and the like are suitably combined with each other and adjusted, to thereby accomplish propagation of light in the photonic crystal mode or the EMC mode in wavelength conversion operation described later.

### B-2. Periodically Poled Portion

The periodically poled portion 14 is provided in at least a portion of the optical waveguide 13. The periodically poled portion 14 is not limited to a particular configuration as long as quasi-phase matching (QPM) can be developed. The periodically poled portion 14 typically has first polarized portions 14a polarized in a c-axis direction of the non-linear optical crystal substrate 11 and second polarized portions 14b (inversely polarized domains) polarized in a direction opposite to the polarization direction of the first polarized portions 14a alternatingly in the waveguide direction of the optical waveguide 13. In the illustrated example, the first polarized portions 14a are polarized in a direction intersecting with the waveguide direction of the optical waveguide 13 and with the thickness direction of the non-linear optical crystal substrate 11. A domain width of each of the first polarized portions 14a and the second polarized portions 14b is adjustable so that output light that has undergone wavelength conversion in the first polarized portions 14a and output light that has undergone wavelength conversion in the second polarized portions 14b have a matching phase.

When an entire length of the optical waveguide 13 is given as 100, the length of the periodically poled portion 14 in the waveguide direction of the optical waveguide 13 is 5 or more and 95 or less in one example, and is 20 or more and 80 or less in another example. A poling period A in the periodically poled portion 14 is, for example, 1 μm or more and 50 μm or less, preferably, 3 μm or more and 30 μm or less. A poling ratio (a inversely polarized domain width/poling period) is, for example, 0.1 or more and 0.9 or less, preferably, 0.3 or more and 0.7 or less.

### B-3. Support Substrate

The support substrate 20 includes an upper surface positioned in a composite substrate and a lower surface exposed to the outside. Any appropriate configuration may be adopted as the support substrate 20. Specific examples of a material for forming the support substrate 20 include indium phosphide (InP), silicon (Si), glass, SiAlON (Si₃N₄—Al₂O₃), mullite (3Al₂O₃·2SiO₂, 2Al₂O₃·3SiO₂), aluminum nitride (AN), magnesium oxide (MgO), aluminum oxide (Al₂O₃), spinel (MgAl₂O₄), sapphire, quartz, crystal, gallium nitride (GaN), silicon carbide (SiC), silicon nitride (Si₃N₄), and gallium oxide (Ga₂O₃).

The support substrate 20 is preferably made of at least one kind selected from the group consisting of indium phosphide, silicon, aluminum nitride, silicon carbide, and silicon nitride, more preferably made of silicon or indium phosphide.

The coefficient of linear expansion of the material for forming the support substrate 20 is preferably as close as possible to the coefficient of linear expansion of the material for forming the non-linear optical crystal substrate 11. Such a configuration can suppress the thermal deformation (typically, warping) of the composite substrate. The coefficient of linear expansion of the material for forming the support substrate 20 preferably falls within the range of from 50% to 150% with respect to the coefficient of linear expansion of the material for forming the non-linear optical crystal substrate 11.

### B-4. Low-Refractive Index Portion

In the wavelength conversion device 100 of the illustrated example, the low-refractive index portion 30 is a cavity 31. The cavity 31 in one embodiment is defined by the lower surface of the non-linear optical crystal substrate 11, the upper surface of the support substrate 20, and the joining portion 80. The low-refractive index portion preferably has a refractive index of 4 or less, and may be, for example, a SiO₂ layer, a quartz glass plate, or a resin layer. When the low-refractive index portion is a cavity, leakage of an electromagnetic wave propagating in the waveguide from the waveguide can be suppressed more stably than when the low-refractive index portion is a SiO₂ layer or a quartz glass plate.

The low-refractive index portion 30 (cavity 31) is typically wider than the optical waveguide 13. The low-refractive index portion 30 (cavity 31) preferably stretches to at least the third lattice row from the optical waveguide 13 and, more preferably, stretches so as to overlap, in the thickness direction of the non-linear optical crystal substrate, with an entirety of the portion in which the holes are formed. In some cases, part of light energy of light propagating inside the optical waveguide diffuses to lattice rows near the optical waveguide and, accordingly, propagation loss can be suppressed by providing the cavity immediately beneath those lattice rows.

A measurement of the low-refractive index portion 30 (cavity 31) in the thickness direction of the non-linear optical crystal substrate is, for example, 0.05 μm or more and 5.0 μm or less, preferably, 0.10 μm or more and 1.0 μm or less.

### B-5. Joining Portion

The joining portion 80 may be a single layer or a multilayer having two or more layers. A SiO₂ layer and an amorphous silicon layer are given as examples of the joining portion 80. In a case in which the joining portion 80 is a SiO₂ layer, the joining portion 80 can function as the low-refractive index portion 30. A thickness of the joining portion 80 is, for example, 0.05 μm or more and 5.0 μm or less.

### B-6. First Electrode and Second Electrode

In one embodiment, the first electrode 40 and the second electrode 50 are placed on a surface (upper surface) of the non-linear optical crystal substrate 11 that is on a side opposite from the support substrate 20. The first electrode 40 and the second electrode 50 are arranged at an interval from each other in a direction perpendicular to the waveguide direction of the optical waveguide 13. The interval between the first electrode 40 and the second electrode 50 in the direction perpendicular to the waveguide direction is typically 5 μm or more and 20 μm or less. In FIG. 1A, the first electrode 40 and the second electrode 50 are each arranged so as not to overlap with the holes 12 and the optical waveguide 13 in the thickness direction of the non-linear optical crystal substrate 11. In this case, each of the first electrode 40 and the second electrode 50 is typically a metal electrode. Examples of a material for forming the metal electrode include titanium (Ti), platinum (Pt), and gold (Au). The metal electrode may be a single layer or a laminate of two or more layers. A thickness of the metal electrode is typically 100 nm or more and 3,000 nm or less.

The first electrode and the second electrode may be placed at any suitable positions as long as the first electrode and the second electrode are electrically connected to the non-linear optical crystal substrate 11. As illustrated in FIG. 2, a first electrode 41 and a second electrode 51 are arranged so as to sandwich the dielectric substrate 10 in the thickness direction. In this case, the non-linear optical crystal substrate 11 is typically a Z-cut substrate. An interval between the first electrode 41 and the second electrode 51 in the thickness direction of the non-linear optical crystal substrate is typically 5.0 μm or less, preferably 1.3 μm or less, and is typically 0.10 μm or more. When the interval between the first electrode and the second electrode is equal to or less than the above-mentioned upper limit, the first electrode and the second electrode can be placed near the optical waveguide, and application of a voltage between the first electrode and the second electrode can accordingly cause the optical waveguide to generate an electric field with efficiency.

The first electrode 41 is placed on a surface (upper surface) of the dielectric substrate 10 that is on a side opposite from the support substrate 20, and overlaps with the optical waveguide 13 in the thickness direction of the non-linear optical crystal substrate 11. In the illustrated example, the first electrode 41 overlaps with, in addition to the optical waveguide 13, all of the holes 12 in the thickness direction.

The second electrode 51 is placed on a surface (lower surface) of the dielectric substrate 10 on a side opposite from the first electrode 41. The second electrode 51 is positioned between the dielectric substrate 10 and the low-refractive index portion 30. The second electrode 51 may be positioned between the dielectric substrate 10 and the joining portion 80 as well. The second electrode 51 overlaps with the optical waveguide 13 in the thickness direction of the non-linear optical crystal substrate 11. In the illustrated example, the second electrode 51 overlaps with all of the holes 12 in the thickness direction of the non-linear optical crystal substrate 11.

When the first electrode and/or the second electrode overlaps the holes, an electric field caused by voltage application can be stably applied to the periodic hole portions, and hence the effective refractive index of the optical waveguide can be efficiently changed. Accordingly, the driving power of the wavelength conversion device can be reduced. In this case, each of the first electrode 41 and the second electrode 51 is typically a transparent electrode. When the first electrode and the second electrode are transparent electrodes, absorption of light propagating through the optical waveguide into the electrodes can be suppressed.

The transmittance of light having a wavelength of 1.025 μm in the transparent electrode is, for example, 80% or more, preferably 90% or more, and is, for example, 100% or less.

Examples of the material for forming the transparent electrode include aluminum-doped zinc oxide (AZO), gallium-doped zinc oxide (GZO), silicon oxide, indium tin oxide (ITO), an In—Ga—Zn—O oxide semiconductor (IGZO), and tin oxide. The transparent electrode may be a single layer or a laminate of two or more layers. The thickness of the transparent electrode is typically 50 nm or more and 300 nm or less.

When the first electrode and/or the second electrode is a metal electrode, a clad layer made of the same material as the material of the low-refractive index portion 30 may be provided between the dielectric substrate 10 and the metal electrode.

### B-7. Diffraction Grating

The diffraction grating 15 is typically provided immediately above the optical waveguide 13 alone. The diffraction grating 15 may be formed in the non-linear optical crystal substrate 11, or may be formed separately from the non-linear optical crystal substrate 11, or may be both of the former and the latter. Any appropriate configuration may be adopted as the diffraction grating 15 as long as light can be emitted from the upper surface of the optical waveguide 13. For example, the diffraction grating may be flat, may be uneven, or may utilize a hologram. In the case of a flat diffraction grating, the pattern of the diffraction grating is formed by, for example, a refractive index difference, and in the case of an uneven diffraction grating, the pattern of the diffraction grating is formed by, for example, a groove or a slit. Typical examples of the pattern of the diffraction grating include a stripe, a lattice, a dot, and a specific shape (for example, a star shape). The directions and pitch of the stripes, the arrangement pattern of the dots, and the like may be appropriately set in accordance with purposes. In one embodiment, the diffraction grating 15 has a plurality of grating grooves extending in a direction substantially perpendicular to the waveguide direction of the optical waveguide 13. Details of a principle of a grating coupler are described in, for example, WO 2018/008183 A1. This publication is incorporated herein in its entirety by reference. The diffraction grating may be periodic holes near the line defect portion of the optical waveguide. In this case, those periodic holes are formed so as to have a period different from the hole period for forming the optical waveguide.

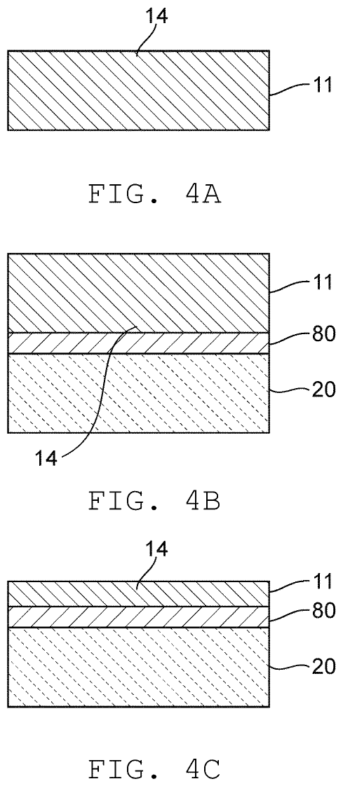

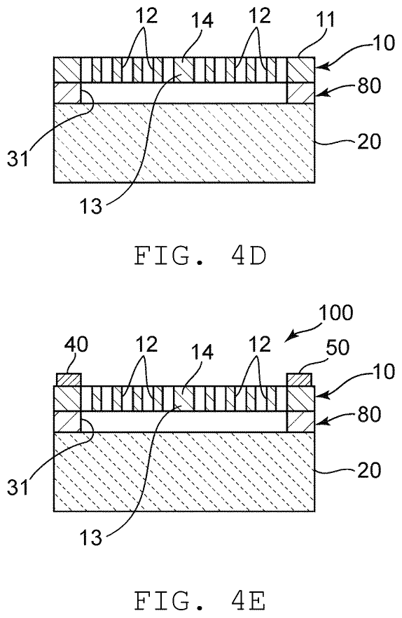

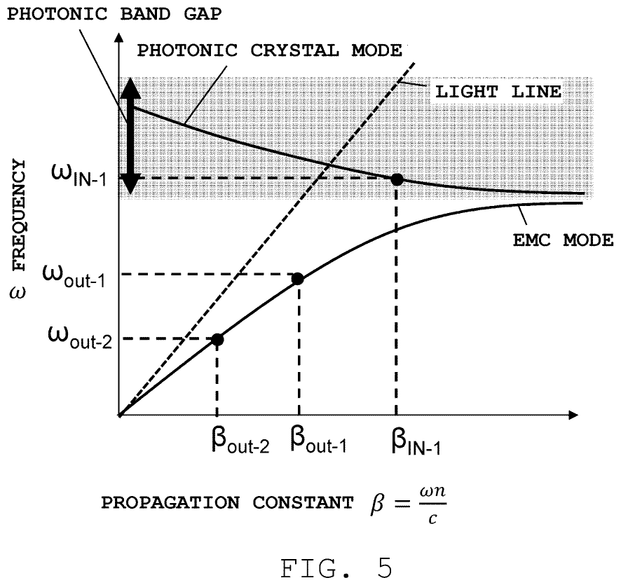

A method of producing a wavelength conversion device according to one embodiment is described next with reference to FIG. 4.

### C. Method of Producing Wavelength Conversion Device

As illustrated in FIG. 4A, first, the non-linear optical crystal substrate 11 is prepared, and the periodically poled portion 14 is formed in a predetermined portion of the non-linear optical crystal substrate 11. Any appropriate method can be adopted as a method of forming the periodically poled portion. In one embodiment, a comb tooth-like electrode pattern is formed on one of the surfaces of the non-linear optical crystal substrate 11. A period of the comb tooth corresponds to the poling period A in the periodically poled portion 14 described above. Next, a voltage is applied to the non-linear optical crystal substrate 11 via the electrode pattern in the direction of the c-axis which is a crystal axis. The periodically poled portion 14 is thus formed. The electrode pattern is then removed by etching.

Next, as illustrated in FIG. 4B, the joining portion 80 is formed by, for example, sputtering, on the surface of the non-linear optical crystal substrate 11 on which the periodically poled portion 14 has been formed. An intermediate layer 1 and an intermediate layer 2 (which are not shown) are then formed by, for example, sputtering, on the surface of the non-linear optical crystal substrate 11 on which the joining portion 80 has been formed, and on the support substrate 20, respectively. Those intermediate layers are then joined to each other by direct joining to obtain a composite substrate expressed as the non-linear optical crystal substrate 11/the joining portion 80/the intermediate layer 1/the intermediate layer 2/the support substrate 20. The intermediate layer 1 may be omitted, and the intermediate layer 2 may be omitted.

The direct joining may be achieved by the following procedure, for example. In a high vacuum chamber (for example, about 1×10⁻⁶ Pa), a neutralized beam is applied to each joining surface of constituents (layers or substrates) to be joined. As a result, each joining surface is activated. Then, in a vacuum atmosphere, the activated joining surfaces are brought into contact with each other and joined to each other at normal temperature. A load at the time of the joining may be, for example, from 100 N to 20,000 N. In one embodiment, when the surface activation is performed with a neutralized beam, an inert gas is introduced into a chamber, and a high voltage is applied from a DC power source to electrodes arranged in the chamber. With such a configuration, electrons move owing to an electric field generated between the electrode (positive electrode) and the chamber (negative electrode), and a beam of atoms and ions caused by the inert gas is generated. Of the beams having reached a grid, an ion beam is neutralized by the grid, and hence the beam of neutral atoms is emitted from a high-speed atom beam source. An atomic species for forming the beam is preferably an inert gas element (for example, argon (Ar) or nitrogen (N)). A voltage at the time of activation by beam irradiation is, for example, from 0.5 kV to 2.0 kV, and an electric current is, for example, from 50 mA to 200 mA. A method for the direct joining is not limited thereto, and a surface activation method including using a fast atom beam (FAB) or an ion gun, an atomic diffusion method, a plasma joining method, or the like may also be applied.

Next, as illustrated in FIG. 4C, the non-linear optical crystal substrate 11 is polished until the thickness range of the non-linear optical crystal substrate described above is reached. Then, as illustrated in FIG. 4D, a plurality of holes 12 are formed in the non-linear optical crystal substrate 11 to obtain the dielectric substrate 10. To describe in detail, a metal mask (for example, a Mo mask) is formed on a surface of the non-linear optical crystal substrate 11 that is on the side opposite from the support substrate 20, and a resin pattern having holes in predetermined arrangement is formed on the metal mask. Subsequently, holes corresponding to the resin pattern are formed in the metal mask by, for example, dry etching (for example, reactive ion etching) through the resin pattern. After that, holes are formed in the non-linear optical crystal substrate 11 by dry etching (for example, reactive ion etching) through the metal pattern having a plurality of holes. Next, the joining portion 80 is partially removed by reactive ion etching or wet etching (for example, immersion in an etchant) to form the cavity 31 (low-refractive index portion 30). After that, the metal mask is removed by wet etching (for example, an etchant).

Next, as illustrated in FIG. 4E, a resist mask pattern that exposes electrode forming portions is formed on the non-linear optical crystal substrate 11 by, for example, photolithography, and the first electrode 40 and the second electrode 50 are formed by, for example, sputtering, via the mask pattern. The resist mask pattern is then removed.

Thus, the wavelength conversion device 100 may be obtained.

It should be understood that a process different from that of the illustrated example may be adopted for the production of the wavelength conversion device. When the overall configuration of the composite substrate, the constituent materials of the respective layers of the composite substrate, the mask, an etching mode, and the like are appropriately combined with each other, the holes and the cavity can be formed by an efficient procedure and with high accuracy, and hence the wavelength conversion device can be produced.

### D. Wavelength Conversion System

The wavelength conversion device 100 described in the section A to the section C described above is applicable to a wavelength conversion system 1. As illustrated in FIG. 1A, the wavelength conversion system 1 includes the wavelength conversion device 100 and a control unit 70 capable of controlling the refractive index of the non-linear optical crystal substrate 11. More specifically, the wavelength conversion system 1 further includes a power source 60 with which a voltage can be applied to the first electrode 40 and the second electrode 50. The control unit 70 is capable of controlling the power source 60, and can adjust the refractive index of the non-linear optical crystal substrate 11 by controlling the voltage to be applied to the first electrode 40 and the second electrode 50. The control unit 70 includes, for example, a central processing unit (CPU), a ROM, and a RAM. The control unit 70 is capable of simulation of respective band curves of the photonic crystal mode and the EMC mode by a plane wave expansion method, details of which are described later. The control unit 70 as described above can adjust the refractive index of the non-linear optical crystal substrate 11 by controlling the power source 60 so that output light having a desired frequency is obtained in each type of wavelength conversion operation.

### E. Wavelength Conversion Operation

In the wavelength conversion device 100 and the wavelength conversion system 1 described above, at least one type of wavelength conversion operation selected from parametric down-conversion (PDC), optical parametric amplification (OPA), second-harmonic generation (SHG), and sum-frequency generation (SFG) is executable.

### E-1. Parametric Down-Conversion (PDC)

In one embodiment, the wavelength conversion device 100 can execute parametric down-conversion (PDC). Specifically, the optical waveguide 13 is configured so as to receive input light input thereto and to output first output light and second output light. The first output light and the second output light are each lower in frequency than the input light. In one embodiment, one of the first output light and the second output light is selected as desired output light, a frequency of the desired output light is set, and the control unit adjusts the refractive index of the non-linear optical crystal substrate so that the input light having a specific frequency is converted into the desired output light. According to this configuration, the first output light and the second output light which are relatively low in frequency can be obtained from the input light having a relatively high frequency.

The frequency of the input light is typically 150 THz or more and 858 THz or less, which is converted into an angular frequency of 9.42×10¹⁴ rad/s or more and 5.386×10¹⁵ rad/s or less. The frequency of each of the first output light and the second output light is typically 20 THz or more and 500 THz or less, which is converted into an angular frequency of 1.26×10¹⁴ rad/s or more and 3.142×10¹⁵ rad/s or less.

The input light, the first output light, and the second output light satisfy the following equation (1-1) and the following equation (2-1). The equation (1-1) relates to the law of conservation of energy and the equation (2-1) relates to a quasi-phase matching condition. The first output light and the second output light can thus be obtained from the input light without fail.

$${ω}_{IN - 1} = {ω}_{OUT - 1} + {ω}_{OUT - 2} \qquad ( 1 - 1 )$$

In the equation (1-1), ω_{IN-1} represents an angular frequency of the input light, ω_{OUT-1} represents an angular frequency of the first output light, and ω_{OUT-2} represents an angular frequency of the second output light.

$$\frac{{ω}_{IN - 1} {n}_{IN - 1}}{c} = \frac{{ω}_{OUT - 1} {n}_{OUT - 1}}{c} + \frac{{ω}_{OUT - 2} {n}_{OUT - 2}}{c} \pm \frac{2 π}{Λ} \qquad ( 2 - 1 )$$

In the equation (2-1), n_{IN-1} represents a refractive index of the non-linear optical crystal substrate with respect to the input light at a predetermined temperature, n_{OUT-1} represents a refractive index of the non-linear optical crystal substrate with respect to the first output light at the predetermined temperature, n_{OUT-2} represents a refractive index of the non-linear optical crystal substrate with respect to the second output light at the predetermined temperature, “c” represents a light speed, A represents a poling period in the periodically poled portion, and ω_{IN-1}, ω_{OUT-1}, and ω_{OUT-2} represent the same angular frequencies as the angular frequencies in the equation (1-1).

Momentum (wavenumber) of the input light and momentum of the output light (the first output light and the second output light) may satisfy (momentum of the input light)> (momentum of the output light), or vice versa, depending on a relationship between the wavelength of the light and the refractive index of the non-linear optical crystal substrate. In a case in which (momentum of the input light)>(momentum of the output light) is true, the input light and the output light satisfy the equation (2-1) when 2π/Λ in the equation (2-1) is “+”. In a case in which (momentum of the input light)<(momentum of the output light) is true, the input light and the output light satisfy the equation (2-1) when 2π/Λ in the equation (2-1) is “−”. In a case in which the quasi-phase matching condition is fulfilled, a phase of the input light and a phase of the output light (the first output light and the second output light) are offset from each other by π, and the phase of the output light can be matched by inverting polarization at a point at which mutual weakening of the output light begins. Accordingly, traveling of the output light and amplification of the output light can be done simultaneously. The same applies to a quasi-phase matching condition of an equation (2-2) to be described later.

In the equation (1-1) and the equation (2-1), the first output light and the second output light may satisfy ω_{OUT-1}=ω_{OUT-2} or may satisfy ω_{OUT-1}>ω_{OUT-2}.

The predetermined temperature in the equation (2-1) is a temperature of the non-linear optical crystal substrate in wavelength conversion operation, and is, for example, room temperature (23° C.). The same applies to predetermined temperatures in equations (2-2), (2-3), and (2-4) to be described later. The term “light speed” as used herein means a light speed in vacuum.

In parametric down-conversion (PDC), the dielectric substrate 10 may function as a photonic crystal with respect to the input light, and function as an effective-medium-clad dielectric with respect to the first output light and the second output light. The dielectric substrate 10 may also function as a photonic crystal with respect to the input light and the first output light, and function as an effective-medium-clad dielectric with respect to the second output light. The dielectric substrate 10 may also function as an effective-medium-clad dielectric with respect to the input light, the first output light, and the second output light. Stable propagation of the input light, the first output light, and the second output light can thus be accomplished.

To describe in more detail, light (the input light, or each of the input light and the first output light) propagated to the dielectric substrate 10 in the photonic crystal mode satisfies the following equation (3). Light (each of the input light, the first output light, and the second output light, or each of the first output light and the second output light, or the second output light) propagated to the dielectric substrate 10 in the EMC mode satisfies the following equation (4).

$$0.35 ≦ \frac{{ω}_{X} α}{2 π c} ≦ 0.45 \qquad ( 3 )$$

In the equation (3), ω_{X} represents an angular frequency of the light propagated to the dielectric substrate in the photonic crystal mode, a represents a period of a periodic hole array, and “c” represents the light speed.

$$0.001 ≦ \frac{{ω}_{Y} α}{2 π c} ≦ 0.3499 \qquad ( 4 )$$

In the equation (4), ω_{Y} represents an angular frequency of the light propagated to the dielectric substrate in the effective-medium-clad dielectric mode, α represents the period of the periodic hole array, and “c” represents the light speed.

### E-2. Optical Parametric Amplification (OPA)

In one embodiment, the wavelength conversion device 100 can execute optical parametric amplification (OPA). Specifically, the optical waveguide 13 is configured so as to receive first input light as pump light and second input light as signal light which are input thereto, and to output first output light which is obtained by amplifying the second input light and second output light as idler light. The second input light is lower in frequency than the first input light. The second output light is lower in frequency than the first input light. In one embodiment, a frequency is set to the first output light as desired output light, and the control unit adjusts the refractive index of the non-linear optical crystal substrate so that the second input light is amplified to the desired first output light. According to this configuration, the first output light relatively high in intensity can be obtained from the second input light relatively low in intensity.

The frequency of the first input light is typically 150 THz or more and 858 THz or less, which is converted into an angular frequency of 9.42×10¹⁴ rad/s or more and 5.385×10¹⁵ rad/s or less. The frequency of each of the second input light, the first output light, and the second output light is typically 20 THz or more and 150 THz or less, which is converted into an angular frequency of 1.26×10¹⁴ rad/s or more and 3.142×10¹⁵ rad/s or less.

The first input light, the second input light, the first output light, and the second output light satisfy the following equation (1-2A), the following equation (1-2B), and the following equation (2-2). The equation (1-2A) and the equation (1-2B) relate to the law of conservation of energy and the equation (2-2) relates to a quasi-phase matching condition. The first output light can thus be obtained from the second input light without fail.

$${ω}_{IN - 1} = {ω}_{OUT - 1} + {ω}_{OUT - 2} \qquad ( 1 - 2 A )$$

In the equation (1-2A), ω_{IN-1} represents an angular frequency of the first input light, ω_{OUT-1} represents an angular frequency of the first output light, and ω_{OUT-2} represents an angular frequency of the second output light.

$${ω}_{IN - 2} = {ω}_{OUT - 1} \qquad ( 1 - 2 B )$$

In the equation (1-2B), ω_{IN-2} represents an angular frequency of the second input light, and ω_{OUT-1} represents an angular frequency of the first output light.

$$\frac{{ω}_{IN - 1} {n}_{IN - 1}}{c} = \frac{{ω}_{OUT - 1} {n}_{OUT - 1}}{c} + \frac{{ω}_{OUT - 2} {n}_{OUT - 2}}{c} \pm \frac{2 π}{Λ} \qquad ( 2 - 2 )$$

In the equation (2-2), n_{IN-1} represents a refractive index of the non-linear optical crystal substrate with respect to the first input light at a predetermined temperature, n_{OUT-1} represents a refractive index of the non-linear optical crystal substrate with respect to the first output light at the predetermined temperature, n_{OUT-2} represents a refractive index of the non-linear optical crystal substrate with respect to the second output light at the predetermined temperature, “c” represents the light speed, A represents a poling period in the periodically poled portion, and ω_{IN-1}, ω_{OUT-1}, and ω_{OUT-2} represent the same angular frequencies as the angular frequencies in the equation (1-2A).

In optical parametric amplification (OPA), the dielectric substrate 10 may function as a photonic crystal with respect to the first input light, and function as an effective-medium-clad dielectric with respect to the second input light, the first output light, and the second output light. The dielectric substrate 10 may also function as a photonic crystal with respect to the first input light, the second input light, and the first output light, and function as an effective-medium-clad dielectric with respect to the second output light. The dielectric substrate 10 may also function as a photonic crystal with respect to the first input light and the second output light, and function as an effective-medium-clad dielectric with respect to the second input light and the first output light. The dielectric substrate 10 may also function as an effective-medium-clad dielectric with respect to the first input light, the second input light, the first output light, and the second output light. Stable propagation of the first input light, the second input light, the first output light, and the second output light can thus be accomplished.

To describe in more detail, light (the first input light, or each of the first input light, the second input light, and the first output light, or each of the first input light and the second output light) propagated to the dielectric substrate 10 in the photonic crystal mode satisfies the equation (3). Light (each of the first input light, the second input light, the first output light, and the second output light, or each of the second input light and the first output light, or the second output light, or each of the second input light, the first output light, and the second output light) propagated to the dielectric substrate 10 in the EMC mode satisfies the equation (4).

### E-3. Second-Harmonic Generation (SHG)

In one embodiment, the wavelength conversion device 100 can execute second-harmonic generation (SHG). Specifically, the optical waveguide 13 is configured so as to receive input light input thereto and to output output light higher in frequency than the input light. In one embodiment, a frequency of the desired output light is set, and the control unit adjusts the refractive index of the non-linear optical crystal substrate so that the input light is converted into the desired output light. According to this configuration, the output light which is relatively high in frequency can be obtained from the input light having a relatively low frequency.

The frequency of the input light is typically 150 THz or more and 428 THz or less, which is converted into an angular frequency of 9.42×10¹⁴ rad/s or more and 2.693×10¹⁵ rad/s or less. The frequency of the output light is typically 300 THz or more and 857 THz or less, which is converted into an angular frequency of 1.885×10¹⁵ rad/s or more and 5.386×10¹⁵ rad/s or less.

The input light and the output light satisfy the following equation (1-3) and the following equation (2-3). The equation (1-3) relates to the law of conservation of energy and the equation (2-3) relates to a quasi-phase matching condition. The output light can thus be obtained from the input light without fail.

$$2 {ω}_{IN - 1} = {ω}_{OUT - 1} \qquad ( 1 - 3 )$$

In the equation (1-3), ω_{IN-1} represents an angular frequency of the input light, and ω_{OUT-1} represents an angular frequency of the output light.

$$2 \frac{{ω}_{I N - 1} {n}_{IN - 1}}{c} \pm \frac{2 π c}{Λ} = \frac{{ω}_{OUT - 1} {n}_{OUT - 1}}{c} \qquad ( 2 - 3 )$$

In the equation (2-3), n_{IN-1} represents a refractive index of the non-linear optical crystal substrate with respect to the input light at a predetermined temperature, n_{OUT-1} represents a refractive index of the non-linear optical crystal substrate with respect to the output light at the predetermined temperature, “c” represents a light speed, A represents a poling period in the periodically poled portion, and ω_{IN-1} and ω_{OUT-1} represent the same angular frequencies as the angular frequencies in the equation (1-3).

In a case in which (momentum of the input light)< (momentum of the output light) is true, the input light and the output light satisfy the equation (2-3) when 2πc/Λ in the equation (2-3) is “+”. In a case in which (momentum of the input light)> (momentum of the output light) is true, the input light and the output light satisfy the equation (2-3) when 2πc/Λ in the equation (2-3) is “−”. Accordingly, traveling of the output light and amplification of the output light can be done simultaneously. The same applies to a quasi-phase matching condition of an equation (2-4) to be described later.

In second-harmonic generation (SHG), the dielectric substrate 10 may function as an effective-medium-clad dielectric with respect to the input light, and function as photonic crystal with respect to the output light. The dielectric substrate 10 may also function as an effective-medium-clad dielectric with respect to the input light and the output light. Stable propagation of the input light and the output light can thus be accomplished.

To describe in more detail, light (the output light) propagated to the dielectric substrate 10 in the photonic crystal mode satisfies the equation (3). Light (the input light, or each of the input light and the output light) propagated to the dielectric substrate 10 in the EMC mode satisfies the equation (4).

### E-4. Sum-Frequency Generation (SFG)

In one embodiment, the wavelength conversion device 100 can execute sum-frequency generation (SFG). Specifically, the optical waveguide 13 is configured so as to receive first input light input thereto and second input light which is input thereto and lower in frequency than the first input light, and to output output light higher in frequency than the first input light and the second input light. In one embodiment, an angular frequency of desired output light is set, and the control unit adjusts the refractive index of the non-linear optical crystal substrate so that the first input light and the second input light are converted into the desired output light. According to this configuration, the output light having a relatively high frequency can be obtained from the first input light and the second input light which are relatively low in frequency.

The frequency of each of the first input light and the second input light is typically 150 THz or more and 428 THz or less, which is converted into an angular frequency of 9.42×10¹⁴ rad/s or more and 2.693×10¹⁵ rad/s or less. The frequency of the output light is typically 300 THz or more and 857 THz or less, which is converted into an angular frequency of 1.885×10¹⁵ rad/s or more and 5.386×10¹⁵ rad/s or less.

The first input light, the second input light, and the output light satisfy the following equation (1-4) and the following equation (2-4). The equation (1-4) relates to the law of conservation of energy and the equation (2-4) relates to a quasi-phase matching condition. The output light can thus be obtained from the first input light and the second input light without fail.

$${ω}_{I N - 1} + {ω}_{IN - 2} = {ω}_{OUT - 1} \qquad ( 1 - 4 )$$

In the equation (1-4), ω_{IN-1} represents an angular frequency of the first input light, ω_{IN-2} represents an angular frequency of the second input light, and ω_{OUT-1} represents a frequency of the output light.

$$\frac{{ω}_{I N - 1} {n}_{IN - 1}}{c} + \frac{{ω}_{IN - 2} {n}_{IN - 2}}{c} \pm \frac{2 π c}{Λ} = \frac{{ω}_{OUT - 1} {n}_{OUT - 1}}{c} \qquad ( 2 - 4 )$$

In the equation (2-4), n_{IN-1} represents a refractive index of the non-linear optical crystal substrate with respect to the first input light at a predetermined temperature, n_{IN-2} represents a refractive index of the non-linear optical crystal substrate with respect to the second input light at the predetermined temperature, n_{OUT-1} represents a refractive index of the non-linear optical crystal substrate with respect to the output light at the predetermined temperature, “c” represents the light speed, A represents a poling period in the periodically poled portion, and ω_{IN-1}, ω_{IN-2}, and ω_{OUT-1} represent the same angular frequencies as the angular frequencies in the equation (1-4).

In sum-frequency generation (SFG), the dielectric substrate 10 may function as a photonic crystal with respect to the output light, and function as an effective-medium-clad dielectric with respect to the first input light and the second input light. The dielectric substrate 10 may also function as a photonic crystal with respect to the first input light and the output light, and function as an effective-medium-clad dielectric with respect to the second input light. The dielectric substrate 10 may also function as an effective-medium-clad dielectric with respect to the first input light, the second input light, and the output light. Stable propagation of the first input light, the second input light, and the output light can thus be accomplished.

To describe in more detail, light (the output light, or each of the first input light and the output light) propagated to the dielectric substrate 10 in the photonic crystal mode satisfies the following equation (3). Light (each of the first input light, the second input light, and the output light, or each of the first input light and the second input light, or the second input light) propagated to the dielectric substrate 10 in the EMC mode satisfies the equation (4).

### EXAMPLES

Now, the present invention is specifically described by way of Examples. However, the present invention is not limited to those Examples. In particular, combinations of input light and output light with a propagation mode in the present invention are not limited to combinations of input light and output light with a propagation mode in wavelength conversion operation of the respective Examples. A method of measuring a propagation loss of a wavelength conversion device is as follows.

### Production Example 1

The wavelength conversion device illustrated in FIG. 1 was produced.

### (1) Periodic Poling

Specifically, a comb tooth-like electrode pattern having a period of 2.0 μm was formed on a Y-cut substrate having an off-cut angle of 5° which had been made from a single crystal of lithium niobate (LN) and which had been doped with MgO, and a voltage was applied in the direction of the c-axis of crystal axes, to thereby form a periodically poled portion. The poling period A in the periodically poled portion was 2.0 μm. A depth of the poled portion was 5 μm in the optical waveguide portion. After the periodic poling, the comb tooth-like electrode was removed by etching. Next, a SiO₂ film was formed by sputtering on a surface on which the periodically poled portion had been formed, to form a clad layer having a thickness of 1 μm. An amorphous silicon (a-Si) film was further formed by sputtering to form an intermediate layer having a thickness of 20 nm. Next, an a-Si film was formed by sputtering on a silicon substrate having a diameter of 4 inches and serving as a support substrate, to form another intermediate layer having a thickness of 20 nm.

### (2) Direct Joining

The intermediate layer (a-Si layer) on each of the lithium niobate substrate and the silicon substrate was then polished by CMP to decrease arithmetic average roughness of each of the intermediate layers to 0.3 nm or less. Next, respective front surfaces of the intermediate layers were washed and directly joined to each other to obtain a composite wafer. For the direct joining, each joining surface was irradiated with a high-speed Ar neutral atom beam (acceleration voltage: 1 kV, Ar flow rate: 60 sccm) for 70 seconds in a vacuum on the order of 10-6 Pa. After the irradiation, each substrate was left to stand still for 10 minutes so as to cool down. The beam-irradiated surface of the lithium niobate substrate and the beam-irradiated surface of the silicon substrate were then brought into contact with each other, and subsequently, were pressurized at 4.90 kN for 2 minutes, to thereby join the two substrates to each other.

### (3) Polishing for Obtaining Thin Plate

After the joining, the lithium niobate substrate was polished down to a thickness of 0.5 μm to obtain a composite substrate for a photonic crystal. No such failure as peeling was observed in a joining interface of the produced composite substrate.

### (4) Formation of Periodic Holes

Next, a Mo film was formed as a metal mask on the lithium niobate substrate. A resin mask having a periodic hole pattern with a period set to 390 nm and a hole radius set to 121 nm was formed next on the metal mask by a nano-imprint method. The resin mask included no-hole portions corresponding to the optical waveguide and etching holes corresponding to etching trenches. The etching holes each had a diameter of 100 μm. On each of an input side and an output side of the optical waveguide, one etching hole was formed on each side of one no-hole portion, at a position ten holes away from the one no-hole portion. That is, four etching holes in total were formed.

Next, portions of the metal mask that were exposed from under the resin mask were removed with a Mo etchant to form the periodic hole pattern and the four etching holes in the metal mask. Portions of the lithium niobate substrate that were exposed from under the metal mask were then removed by fluorine-based reactive ion etching to form the periodic hole pattern and four etching trenches in the lithium niobate substrate. A dielectric substrate having a periodic hole pattern was thus formed. At that point, a portion of the clad layer that corresponds to the periodic hole pattern of the lithium niobate substrate was removed by fluorine-based reactive ion etching as well.

The composite substrate was then immersed in a buffered hydrofluoric acid (BHF) etchant to etch the clad layer (a silicon oxide). The holes were thus formed. Remaining portions of the metal mask were then removed with an etchant.

### (5) Formation of Electrodes

Next, resist was applied to the lithium niobate substrate to form an electrode pattern by exposure and development with use of a mask aligner. A Ti film, a Pt film, and a Au film were further formed by sputtering to thicknesses of 20 nm, 100 nm, and 0.5 μm, respectively. The resist was then peeled with an organic solvent, and the first electrode and the second electrode were formed by lift-off.

Next, the resultant composite substrate was cut into chips by dicing, to produce the wavelength conversion device. An optical waveguide length in the wavelength conversion device was 10 mm. An input end surface and an output end surface of the optical waveguide in the dielectric substrate were each polished. A power source was electrically connected to the first electrode and the second electrode. The control unit was electrically connected to the power source. The control unit is capable of controlling the power source and can simulate respective band curves in the photonic crystal mode and the EMC mode by the plane wave expansion method.

### Production Example 2

A wavelength conversion device was produced in the same manner as in Production Example 1, except that the poling period A was changed to 1.0 μm, and the control unit was connected to the wavelength conversion device.

### Example 1: Parametric Down-Conversion (PDC)

In the wavelength conversion device of Production Example 1, a DFB laser (light source) was connected to the input side of the optical waveguide. The DFB laser (light source) is capable of emitting laser light (input light) having an angular frequency of 2.36×10¹⁵ rad/s (wavelength: 0.8 μm, 375 THz).

Next, in the control unit, the angular frequency ω_{OUT-1} (4.71×10¹⁴ rad/s, wavelength: 4 μm, 75 THz) of the first output light (converted light) was set as desired output light. The control unit calculated a range (n_{IN-1}) of refractive indices that the non-linear optical crystal substrate might take with respect to the input light, and a range (n_{OUT-1}) of refractive indices that the non-linear optical crystal substrate might take with respect to the first output light, based on the temperature (23° C.), the angular frequency ω_{IN-1} of the input light, the angular frequency ω_{OUT-1} of the first output light, and a voltage applicable to the non-linear optical crystal substrate.

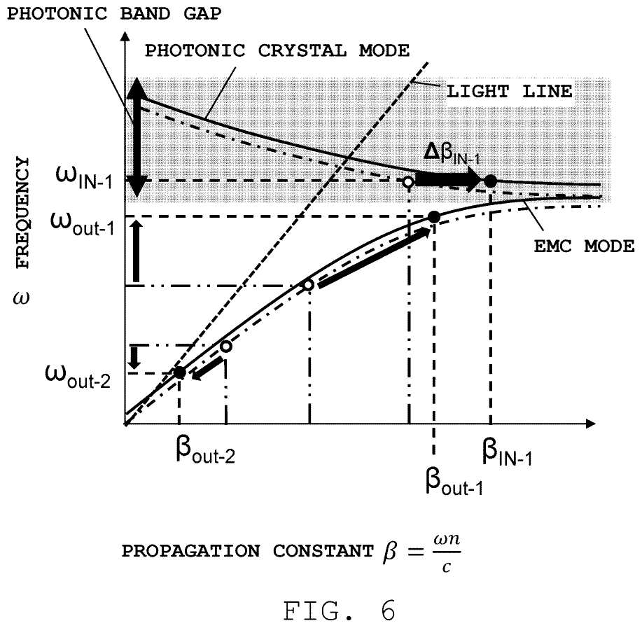

The control unit also simulated respective band curves of the photonic crystal mode and the EMC mode by the plane wave expansion method as shown in FIG. 5. In FIG. 5, an axis of ordinate indicates the angular frequency ω of light. An axis of abscissa indicates a propagation constant β, which is (angular frequency ω of light×refractive index “n” of non-linear optical crystal substrate)/light speed “c”.

Next, the control unit calculated, based on the angular frequency ω_{IN-1} of the input light, the angular frequency ω_{OUT-1} Of the first output light, and the range (n_{IN-1}) and the range (n_{OUT-1}) of refractive indices that the non-linear optical crystal substrate might take, a combination (ω_{IN-1}, ω_{OUT-1}, and ω_{OUT-2}) of the angular frequency ω_{IN-1} of the input light, the angular frequency ω_{OUT-1} of the first output light, and the angular frequency ω_{OUT-2} of the second output light that caused the input light, the first output light, and the second output light to satisfy the equation (1-1) and the equation (2-1), that caused the input light to satisfy the equation (3) and fall on the band curve of the photonic crystal mode, and that caused each of the first output light and the second output light to satisfy the equation (4) and fall on the band curve of the EMC mode.

A voltage (+50 V) to be applied to the non-linear optical crystal substrate was determined from the obtained combination of the angular frequencies (ω_{IN-1}, ω_{OUT-1}, and ω_{OUT-2}). Next, the determined voltage was applied to the non-linear optical crystal substrate to adjust the refractive index, and then the input light was input to the optical waveguide. That the first output light having the desired angular frequency of 4.71×10¹⁴ rad/s (wavelength: 4 μm, 75 THz) and the second output light having an angular frequency of 18.85×10¹⁴ rad/s (wavelength: 1 μm, 300 THz) were output as a result from the optical waveguide was confirmed with use of an optical spectrum analyzer.

Another run of wavelength conversion was executed in the same manner as the one described above, except that the desired angular frequency ω_{OUT-1} set to the first output light in the control unit was changed to 7.85×10¹⁴ rad/s (wavelength: 2.4 μm, 125 THz).

As shown in FIG. 6, the change to the desired angular frequency of the output light caused the respective band curves of the photonic crystal mode and the EMC mode to shift (from the dot-dash line to the solid line) in simulation by the plane wave expansion method. The shift in this case was confirmed to be greater for the photonic crystal mode than the EMC mode. The control unit calculated a combination (ω_{IN-1}, ω_{OUT-1}, and ω_{OUT-2}) Of the angular frequency ω_{IN-1} of the input light, the angular frequency ω_{OUT-1} of the first output light, and the angular frequency ω_{OUT-2} of the second output light that caused the input light, the first output light, and the second output light to satisfy the equation (1-1) and the equation (2-1), that caused the input light to satisfy the equation (3) and fall on a post-shift band curve of the photonic crystal mode, and that caused each of the first output light and the second output light to satisfy the equation (4) and fall on a post-shift band curve of the EMC mode. A voltage (−50 V) to be applied to the non-linear optical crystal substrate was determined from the obtained combination of the angular frequencies (ω_{IN-1}, ω_{OUT-1}, and ω_{OUT-2}). That the first output light having the desired angular frequency ω_{OUT-1} was output from the optical waveguide was confirmed in this run of wavelength conversion as well.

### Example 2: Optical Parametric Amplification (OPA)

In the wavelength conversion device of Production Example 1, a high-power semiconductor laser (first light source) and a laser (second light source) of a plurality of wavelengths (capable of discretely varying the wavelength) were connected to the input side of the optical waveguide. The high-power semiconductor laser (first light source) is capable of emitting laser light (first input light) having an angular frequency of 2.36×10¹⁵ rad/s (wavelength: 0.8 μm, 375 THz), and the laser (second light source) is capable of emitting laser light (second input light) having an angular frequency of from 4.71×10¹⁴ rad/s (wavelength: 4.0 μm, 75 THz) to 1.88×10¹⁵ rad/s (wavelength: 1.0 μm, 300 THz).

Next, in the control unit, the angular frequency ω_{OUT-1} (4.71×10¹⁴ rad/s, wavelength: 4.0 μm, 75 THz) of the first output light (converted light) was set as desired output light. The control unit calculated a range (n_{IN-1}) of refractive indices that the non-linear optical crystal substrate might take with respect to the first input light, a range (n_{IN-2}) of refractive indices that the non-linear optical crystal substrate might take with respect to the second input light, and a range (n_{OUT-1}) of refractive indices that the non-linear optical crystal substrate might take with respect to the first output light, based on the temperature (23° C.), the angular frequency ω_{IN-1} of the first input light, the angular frequency ω_{IN-2} of the second input light, the angular frequency ω_{OUT-1} of the first output light, and a voltage applicable to the non-linear optical crystal substrate.

Next, the control unit calculated, based on the angular frequency ω_{IN-1} of the first input light, the angular frequency ω_{IN-2} of the second input light, the angular frequency ω_{OUT-1} of the first output light, and the ranges n_{IN-1}, n_{IN-2}, and n_{OUT-1} of refractive indices that the non-linear optical crystal substrate might take, a combination (ω_{IN-1}, ω_{IN-2}, ω_{OUT-1}, and ω_{OUT-2}) of the angular frequency ω_{IN-1} of the first input light, the angular frequency ω_{IN-2} of the second input light, the angular frequency ω_{OUT-1} of the first output light, and the angular frequency ω_{OUT-2} Of the second output light that caused the first input light, the second input light, the first output light, and the second output light to satisfy the equation (1-2A), the equation (1-2B), and the equation (2-2), that caused the first input light to satisfy the equation (3) and fall on the band curve of the photonic crystal mode, and that caused each of the second input light, the first output light, and the second output light to satisfy the equation (4) and fall on the band curve of the EMC mode.

A voltage (+50 V) to be applied to the non-linear optical crystal substrate was determined from the obtained combination of the angular frequencies (ω_{IN-1}, ω_{IN-2}, ω_{OUT-1}, and ω_{OUT-2}). Next, the determined voltage was applied to the non-linear optical crystal substrate to adjust the refractive index, and then the first input light and the second input light were input to the optical waveguide. That the first output light having the desired angular frequency of 4.71×10¹⁴ rad/s (wavelength: 4.0 μm, 75 THz) and having been amplified was output as a result from the optical waveguide was confirmed with the use of the optical spectrum analyzer.

Another run of wavelength conversion was executed in the same manner as the one described above, except that the desired angular frequency set to the first output light in the control unit was changed to 7.85×10¹⁴ rad/s (wavelength: 2.4 μm, 124 THz). A voltage applied to the non-linear optical crystal substrate in this case was-50 V. That the first output light having the desired angular frequency and having been amplified was output from the optical waveguide was confirmed in this run of wavelength conversion as well.

### Example 3: Second-Harmonic Generation (SHG)

In the wavelength conversion device of Production Example 2, a titanium-sapphire laser (light source) was connected to the input side of the optical waveguide. The titanium-sapphire laser is capable of emitting laser light (input light) having an angular frequency of from 1.90×10¹⁵ rad/s to 2.69×10¹⁵ rad/s (wavelength: from 700 nm to 990 nm, from 302.8 THz to 428.3 THz).

Next, in the control unit, a desired value (4.71×10¹⁵ rad/s, wavelength: 400 nm, 749.5 THz) was set as the angular frequency ω_{OUT-1} of the output light (converted light). The control unit calculated a range (n_{IN-1}) of refractive indices that the non-linear optical crystal substrate might take with respect to the input light, and a range (n_{OUT-1}) of refractive indices that the non-linear optical crystal substrate might take with respect to the output light, based on the temperature (23° C.), the angular frequency ω_{IN-1} of the input light, the angular frequency ω_{OUT-1} Of the output light, and a voltage applicable to the non-linear optical crystal substrate.

Next, the control unit calculated, based on the angular frequency ω_{IN-1} of the input light, the angular frequency ω_{OUT-1} Of the output light, and the range (n_{IN-1}) and the range (n_{OUT-1}) of refractive indices that the non-linear optical crystal substrate might take, a combination (ω_{IN-1} and ω_{OUT-1}) of the angular frequency ω_{IN-1} of the input light and the angular frequency ω_{OUT-1} of the output light that caused the input light and the output light to satisfy the equation (1-3) and the equation (2-3), that caused the output light to satisfy the equation (3) and fall on the band curve of the photonic crystal mode, and that caused the input light to satisfy the equation (4) and fall on the band curve of the EMC mode.

A voltage to be applied to the non-linear optical crystal substrate was determined from the obtained combination of the angular frequencies (ω_{IN-1} and ω_{OUT-1}). Next, the voltage (+50 V) was applied to the non-linear optical crystal substrate to adjust the refractive index, and then the input light (angular frequency: 2.35×10¹⁵ rad/s) was input to the optical waveguide. That the output light having the desired angular frequency of 4.71×10¹⁵ rad/s (wavelength: 400 nm, 749.5 THz) was output as a result from the optical waveguide was confirmed with the use of the optical spectrum analyzer.

Another run of wavelength conversion was executed in the same manner as the one described above, except that the desired angular frequency set to the output light in the control unit was changed to 4.19×10¹⁵ rad/s (wavelength: 450 nm, 666.2 THz). At this time, the angular frequency of the input light was set to 2.09×10¹⁵ rad/s. A voltage applied to the non-linear optical crystal substrate in this case was-50 V. That the output light having the desired angular frequency was output from the optical waveguide was confirmed in this run of wavelength conversion as well.

### Example 4: Sum-Frequency Generation (SFG)

In the wavelength conversion device of Production Example 2, two titanium-sapphire lasers (first light source and second light source) were connected to the input side of the optical waveguide. The titanium-sapphire laser is capable of emitting laser light (first input light or second input light) having an angular frequency of from 1.90×10¹⁵ rad/s to 2.69×10¹⁵ rad/s (wavelength: from 700 nm to 990 nm, from 302.8 THz to 428.3 THz).

Next, in the control unit, the angular frequency ω_{OUT-1} (4.71×10¹⁵ rad/s, wavelength: 400 nm, 749.5 THz) of desired output light (converted light) was set. The control unit calculated a range (n_{IN-1}) of refractive indices that the non-linear optical crystal substrate might take with respect to the first input light, a range (n_{IN-2}) of refractive indices that the non-linear optical crystal substrate might take with respect to the second input light, and a range (n_{OUT-1}) of refractive indices that the non-linear optical crystal substrate might take with respect to the output light, based on the temperature (23° C.), the angular frequency ω_{IN-1} (2.51×10¹⁵ rad/s, wavelength: 750 nm, 399.7 THz) of the first input light, the angular frequency ω_{IN-2} (2.19×10¹⁵ rad/s, wavelength: 858 nm, 349.4 THz) of the second input light, the angular frequency ω_{OUT-1} (4.71×10¹⁵ rad/s, wavelength: 400 nm, 749.5 THz) of the output light, and a voltage applicable to the non-linear optical crystal substrate.

Next, the control unit calculated, based on the angular frequency ω_{IN-1} of the first input light, the angular frequency ω_{IN-2} of the second input light, the angular frequency ω_{OUT-1} of the output light, and the range (n_{IN-1}), the range (n_{IN-2}), and the range (n_{OUT-1}) of refractive indices that the non-linear optical crystal substrate might take, a combination (ω_{IN-1}, ω_{IN-2}, and ω_{OUT-1}) of the angular frequency ω_{IN-1} of the first input light, the angular frequency ω_{IN-2} of the second input light, and the angular frequency ω_{OUT-1} of the output light that caused the first input light, the second input light, and the output light to satisfy the equation (1-4) and the equation (2-4), that caused the output light to satisfy the equation (3) and fall on the band curve of the photonic crystal mode, and that caused each of the first input light and the second input light to satisfy the equation (4) and fall on the band curve of the EMC mode.

A voltage (+50 V) to be applied to the non-linear optical crystal substrate was determined from the obtained combination of the angular frequencies (ω_{IN-1}, ω_{IN-2}, and ω_{OUT-1}). Next, the determined voltage was applied to the non-linear optical crystal substrate to adjust the refractive index, and then the first input light and the second input light were input to the optical waveguide. That the output light having the desired angular frequency (4.71×10¹⁵ rad/s, wavelength: 400 nm, 749.5 THz) was output as a result from the optical waveguide was confirmed with the use of the optical spectrum analyzer.

Another run of wavelength conversion was executed in the same manner as the one described above, except that the desired angular frequency of the output light to be input to the control unit was changed to 4.19×10¹⁵ rad/s (wavelength: 450 nm, 666.2 THz). At this time, the angular frequency ω_{IN-1} of the first input light was set to 2.19×10¹⁵ rad/s (wavelength: 860 nm, 349 THz), and the angular frequency ω_{IN-2} of the second input light was set to 1.97×10¹⁵ rad/s (wavelength: 944 nm, 318 THz). A voltage applied to the non-linear optical crystal substrate in this case was-50 V. That the output light having the desired angular frequency was output from the optical waveguide was confirmed in this run of wavelength conversion as well.

### Comparative Example 1

A wavelength conversion device illustrated in FIG. 4 of Patent Literature 1 was prepared and used to perform wavelength conversion in which input light having an angular frequency of 2.35×10¹⁵ rad/s (wavelength: 800 nm, 374.7 THz) was converted into output light having an angular frequency of 4.71×10¹⁵ rad/s (wavelength: 400 nm, 749.5 THz).

The input light was input to a line-defect waveguide in a photonic crystal mode, but the output light, having a wavelength outside a wavelength range corresponding to a photonic band gap, was radiated upward of the wavelength conversion device instead of propagating in the line-defect waveguide.

The wavelength conversion devices according to the embodiments of the present invention are applicable to a wide range of fields including next-generation high-speed communication and quantum technology, and are particularly favorably usable as an optical amplifier and as an optical modulator.

What is claimed is:

1. A wavelength conversion device, comprising:
a dielectric substrate having holes periodically formed in a non-linear optical crystal substrate;
a line-defect optical waveguide formed in the dielectric substrate; and
a periodically poled portion provided in the line-defect optical waveguide,
wherein the dielectric substrate is configured to function as one of a photonic crystal and an effective-medium-clad dielectric with respect to at least one beam of input light input to the line-defect optical waveguide, and function as another of the photonic crystal and the effective-medium-clad dielectric with respect to at least one beam of output light output from the line-defect optical waveguide, and
wherein the wavelength conversion device is configured to convert a wavelength of light traveling through the line-defect optical waveguide.

2. The wavelength conversion device according to claim 1, wherein the line-defect optical waveguide is configured to receive input light input thereto, and output first output light and second output light which are lower in frequency than the input light.

3. The wavelength conversion device according to claim 2, wherein the dielectric substrate is configured to function as the photonic crystal with respect to the input light, and function as the effective-medium-clad dielectric with respect to the first output light and the second output light.

4. The wavelength conversion device according to claim 2, wherein the dielectric substrate is configured to function as the photonic crystal with respect to the input light and the first output light, and function as the effective-medium-clad dielectric with respect to the second output light.

5. The wavelength conversion device according to claim 2, wherein the input light, the first output light, and the second output light satisfy the following equation (1-1) and the following equation (2-1):
$${ω}_{I N - 1} = {ω}_{OUT - 1} + {ω}_{OUT - 2} \qquad ( 1 - 1 )$$
where ω_{IN-1} represents an angular frequency of the input light, ω_{OUT-1} represents an angular frequency of the first output light, and ω_{OUT-2} represents an angular frequency of the second output light; and
$$\frac{{ω}_{I N - 1} {n}_{IN - 1}}{c} = \frac{{ω}_{OUT - 1} {n}_{OUT - 1}}{c} + \frac{{ω}_{OUT - 2} {n}_{OUT - 2}}{c} \pm \frac{2 π}{Λ} \qquad ( 2 - 1 )$$
where n_{IN-1} represents a refractive index of the non-linear optical crystal substrate with respect to the input light at a predetermined temperature, n_{OUT-1} represents a refractive index of the non-linear optical crystal substrate with respect to the first output light at the predetermined temperature, n_{OUT-2} represents a refractive index of the non-linear optical crystal substrate with respect to the second output light at the predetermined temperature, “c” represents a light speed, A represents a poling period in the periodically poled portion, and ω_{IN-1}, ω_{OUT-1}, and ω_{OUT-2} represent the same angular frequencies as the angular frequencies in the equation (1-1).

6. The wavelength conversion device according to claim 1, wherein the line-defect optical waveguide is configured to:
receive first input light and second input light which are input thereto, the second input light being lower in frequency than the first input light;
output first output light obtained by amplifying the second input light; and
output second output light lower in frequency than the first input light.

7. The wavelength conversion device according to claim 6, wherein the dielectric substrate is configured to function as the photonic crystal with respect to the first input light, and function as the effective-medium-clad dielectric with respect to the second input light, the first output light, and the second output light.

8. The wavelength conversion device according to claim 6, wherein the dielectric substrate is configured to function as the photonic crystal with respect to the first input light, the second input light, and the first output light, and function as the effective-medium-clad dielectric with respect to the second output light.

9. The wavelength conversion device according to claim 6, wherein the dielectric substrate is configured to function as the photonic crystal with respect to the first input light and the second output light, and function as the effective-medium-clad dielectric with respect to the second input light and the first output light.

10. The wavelength conversion device according to claim 6, wherein the first input light, the second input light, the first output light, and the second output light satisfy the following equation (1-2A), the following equation (1-2B), and the following equation (2-2):
$${ω}_{I N - 1} = {ω}_{OUT - 1} + {ω}_{OUT - 2} \qquad ( 1 - 2 A )$$
where ω_{IN-1} represents an angular frequency of the first input light, ω_{OUT-1} represents an angular frequency of the first output light, and ω_{OUT-2} represents an angular frequency of the second output light;
$${ω}_{I N - 2} = {ω}_{OUT - 1} \qquad ( 1 - 2 B )$$
where ω_{IN-2} represents an angular frequency of the second input light, and ω_{OUT-1} represents the angular frequency of the first output light; and
$$\frac{{ω}_{I N - 1} {n}_{IN - 1}}{c} = \frac{{ω}_{OUT - 1} {n}_{OUT - 1}}{c} + \frac{{ω}_{OUT - 2} {n}_{OUT - 2}}{c} \pm \frac{2 π}{Λ} \qquad ( 2 - 2 )$$
where n_{IN-1} represents a refractive index of the non-linear optical crystal substrate with respect to the first input light at a predetermined temperature, n_{OUT-1} represents a refractive index of the non-linear optical crystal substrate with respect to the first output light at the predetermined temperature, n_{OUT-2} represents a refractive index of the non-linear optical crystal substrate with respect to the second output light at the predetermined temperature, “c” represents a light speed, A represents a poling period in the periodically poled portion, and ω_{IN-1}, ω_{OUT-1}, and ω_{OUT-2} represent the same angular frequencies as the angular frequencies in the equation (1-2A).

11. The wavelength conversion device according to claim 1, wherein the line-defect optical waveguide is configured to receive input light input thereto, and output output light higher in frequency than the input light.

12. The wavelength conversion device according to claim 11, wherein the dielectric substrate is configured to function as the effective-medium-clad dielectric with respect to the input light, and function as the photonic crystal with respect to the output light.

13. The wavelength conversion device according to claim 11, wherein the input light and the output light satisfy the following equation (1-3) and the following equation (2-3):
$$2 {ω}_{IN - 1} = {ω}_{OUT - 1} \qquad ( 1 - 3 )$$
where ω_{IN-1} represents an angular frequency of the input light, and ω_{OUT-1} represents an angular frequency of the output light; and
$$2 \frac{{ω}_{I N - 1} {n}_{IN - 1}}{c} \pm \frac{2 π c}{Λ} = \frac{{ω}_{OUT - 1} {n}_{OUT - 1}}{c} \qquad ( 2 - 3 )$$
where n_{IN-1} represents a refractive index of the non-linear optical crystal substrate with respect to the input light at a predetermined temperature, n_{OUT-1} represents a refractive index of the non-linear optical crystal substrate with respect to the output light at the predetermined temperature, “c” represents a light speed, A represents a poling period in the periodically poled portion, and ω_{IN-1} and ω_{OUT-1} represent the same angular frequencies as the angular frequencies in the equation (1-3).

14. The wavelength conversion device according to claim 1, wherein the line-defect optical waveguide is configured to:
receive first input light and second input light which are input thereto, the second input light being lower in frequency than the first input light; and
output output light higher in frequency than the first input light and the second input light.

15. The wavelength conversion device according to claim 14, wherein the dielectric substrate is configured to function as the photonic crystal with respect to the output light, and function as the effective-medium-clad dielectric with respect to the first input light and the second input light.

16. The wavelength conversion device according to claim 14, wherein the dielectric substrate is configured to function as the photonic crystal with respect to the first input light and the output light, and function as the effective-medium-clad dielectric with respect to the second input light.

17. The wavelength conversion device according to claim 14, wherein the first input light, the second input light, and the output light satisfy the following equation (1-4) and the following equation (2-4):
$${ω}_{I N - 1} + {ω}_{IN - 2} = {ω}_{OUT - 1} \qquad ( 1 - 4 )$$
where ω_{IN-1} represents an angular frequency of the first input light, ω_{IN-2} represents an angular frequency of the second input light, and ω_{OUT-1} represents an angular frequency of the output light; and
$$\frac{{ω}_{I N - 1} {n}_{IN - 1}}{c} + \frac{{ω}_{IN - 2} {n}_{IN - 2}}{c} \pm \frac{2 π c}{Λ} = \frac{{ω}_{OUT - 1} {n}_{OUT - 1}}{c} \qquad ( 2 - 4 )$$
where n_{IN-1} represents a refractive index of the non-linear optical crystal substrate with respect to the first input light at a predetermined temperature, n_{IN-2} represents a refractive index of the non-linear optical crystal substrate with respect to the second input light at the predetermined temperature, n_{OUT-1} represents a refractive index of the non-linear optical crystal substrate with respect to the output light at the predetermined temperature, “c” represents a light speed, A represents a poling period in the periodically poled portion, and ω_{IN-1}, ω_{IN-2}, and ω_{OUT-1} represent the same angular frequencies as the angular frequencies in the equation (1-4).

18. The wavelength conversion device according to claim 1, wherein, out of the input light and the output light, light propagated to the dielectric substrate in a photonic crystal mode satisfies the following equation (3), and light propagated to the dielectric substrate in an effective-medium-clad dielectric mode satisfies the following equation (4):
$$0.35 ≦ \frac{{ω}_{X} α}{2 π c} ≦ 0.45 \qquad ( 3 )$$
where ω_{X} represents an angular frequency of the light propagated to the dielectric substrate in the photonic crystal mode, a represents a period of a periodic hole array, and “c” represents a light speed; and
$$0.001 ≦ \frac{{ω}_{Y} α}{2 π c} ≦ 0.3 \; 499 \qquad ( 4 )$$
where ω_{Y} represents an angular frequency of the light propagated to the dielectric substrate e in the effective-medium-clad dielectric mode, a represents the period of the periodic hole array, and “c” represents the light speed.

19. The wavelength conversion device according to claim 1, further comprising:
a support substrate provided below the non-linear optical crystal substrate; and
a low-refractive index portion which has a refractive index lower than a refractive index of the non-linear optical crystal substrate, and which is positioned between the non-linear optical crystal substrate and the support substrate,
wherein at least part of the low-refractive index portion overlaps with the line-defect optical waveguide in a thickness direction of the non-linear optical crystal substrate.

20. The wavelength conversion device according to claim 1, further comprising a diffraction grating which is provided in the line-defect optical waveguide, and which is arranged so as to be side by side with the periodically poled portion in a waveguide direction of the line-defect optical waveguide,
wherein the wavelength conversion device is configured to emit, from the line-defect optical waveguide, light converted in wavelength in the line-defect optical waveguide.

21. The wavelength conversion device according to claim 1, further comprising a first electrode and a second electrode which are electrically connected to the non-linear optical crystal substrate.

22. A wavelength conversion system, comprising:
the wavelength conversion device of claim 1; and
a control unit configured to control a refractive index of the non-linear optical crystal substrate.

23. The wavelength conversion system according to claim 22, further comprising:
a first electrode and a second electrode which are electrically connected to the non-linear optical crystal substrate, and which are positioned at an interval from each other; and
a power source configured to apply a voltage to the first electrode and the second electrode,
wherein the control unit is configured to control the power source, and adjust the refractive index of the non-linear optical crystal substrate by controlling the voltage applied to the first electrode and the second electrode.
